(19) United States
(12) Patent Application Publication
(10) Pub. No.: US 2007/0289958 A1
(43) Pub. Date: Dec. 20, 2007

(54) Adaptive tooling

(76) Inventors: Daniel Clark, Derby (GB); Barry D Smith, Hathern (GB); Alexander Kutscherawy, Derby (GB); George W Whitehurst, Derby (GB)

Correspondence Address: MANELLI DENISON & SELTER, 2000 M STREET NW SUITE 700, WASHINGTON, DC, 20036-3307, US

(21) Appl. No.: 11/806,564

(22) Filed: Jun. 1, 2007

(30) Foreign Application Priority Data
Jun. 3, 2006 (GB) 0610966.4

(51) Int. Cl. B23K 9/06

(52) U.S. Cl. 219/124.01

(57) ABSTRACT

Apparatus for supporting a work-piece during an additive process where material is added to a first surface of the work-piece. The support has a thermally conductive heat-sink adapted to act against a reverse side of the work-piece to that to which material is added thereby supporting the work-piece. The thermally conductive heat-sink is mounted to a biasing means that in use biases the thermally conductive heat-sink against the reverse side of the work-piece.

This invention concerns adaptive tooling for use in the manufacture of a component and in particular for tooling used in the additive addition of material to a component using a high temperature process, especially where the component is relatively thin.

Additive processes such as shaped metal deposition (SMD) allow the creation of features onto the surface of a component by selective deposition of a molten material. The deposition may be enabled by processes such as TIG, MIG and EB welding, or by direct laser deposition (DLD). The structures can be built with increased efficiency as material usage is more efficient. However, the additive process, which is usually performed at high temperatures can affect the integrity of the component, especially where the integrity is dependent on the cooling rate. The process can also cause the component to distort.

In a known process the cooling rate is controlled by gas chilling, which requires a high volume cryogenic gas handling system. Additionally, care must be taken during cooling not to contaminate the component, especially where the component is made molten because of heat input by the additive process.

It is an object of the present invention to seek to provide improved tooling for use in the manufacture of a component and in particular for tooling used in the additive addition of material to a component using a high temperature process, especially where the component is relatively thin, and a method of operation of the tooling.

According to the present invention there is provided apparatus for supporting a work-piece during an additive process where material is added to a first surface of the work-piece, the apparatus comprising a thermally conductive heat-sink adapted to act against a reverse side of the work-piece to that to which material is added thereby supporting the work-piece, wherein the thermally conductive heat-sink is mounted to a biasing means that in use biases the thermally conductive heat-sink against the reverse side of the work-piece.

The invention enables greater possibilities when adding material to high value applications such as large nickel alloy or superalloy structures that have a high integrity but are relatively thin. Specific examples are combustion and turbine casing structures. Nickel alloys are sensitive to variations in cooling rate and the invention assists in maintaining the integrity of depositions without loss in deposition rates.

The heat-sink is biased against component to bring it into contact with the hot regions. However, the biasing applies pressure and the pressure is preferably balanced so as to induce a loading that is sufficient to support the thermally softened and strained component. Therefore, the biasing means may be adjustable to allow the thermally conductive heat-sink to move independently of the work-piece. Preferably a uniform pressure is applied to the reverse surface of the workpiece by the heat-sink throughout the additive procedure.

Alloy structures are generally cast or forged and the deposited material onto the component will, with the component, be dynamic as a result of varying thermal flux induced by the high temperature of the added material as it is deposited. Preferably the thermally conductive heat-sink has a face that conforms with the reverse side of the work-piece, wherein the biasing means is adjustable to move the thermally conductive heat-sink in a direction that is generally perpendicular to the plane of the face. The conforming of the heat-sink to the reverse side of the work-piece provides a good thermal coupling.

Therefore, for an annular component the thermally conductive heat-sink preferably has a curved face that abuts the reverse side of the work-piece and the biasing means is adjustable to move the thermally conductive heat-sink in a direction that is generally perpendicular to the tangent of the face. The curved face may be convex for an internal support and concave for an external support.

Preferably, the biasing means comprises a mount element to which one end of a first arm is pivotally attached, a support element for supporting the thermally conductive heat-sink pivotally attached to a second end of the first arm, a second arm having a first end pivotally attached to the support element and a second end pivotally attached to an actuator element adapted to move in use to move thermally conductive heat-sink independently of the work-piece.

The movement of the thermally conductive heat-sink may be orthogonal to the reverse side of the work-piece.

The movement of the actuator element may be orthogonal to the movement of the thermally conductive heat-sink.

Preferably the actuator element moves linearly and is functionally mounted to a screw thread actuator or linear actuator.

The work-piece may be cylindrical with the thermally conductive heat-sink acting against the internal surface of the work-piece.

Preferably the thermally conductive heat-sink is provided with a temperature adjusting circuit for the supply and removal of a coolant or heating medium to the heat-sink.

Advantageously, the temperature adjusting circuit may be coupled to a feedback control system to accommodate the changing stress state and the differing states of thermal expansion and contraction in the deposited structures measured by thermal and strain sensors coupled to the component.

The work-piece may also be cylindrical with the thermally conductive heat sink acts against the external surface of the work-piece.

The thermally conductive heat-sink may comprise a band of conductive material that encircles a portion of the external surface of the work-piece. The band may be formed of a series of pivotally connected segments.

The band of conductive material may comprise a first end with a face and second end with a face, wherein the first face and the second face are held adjacent to each other by the biasing means which allows a gap between the first and second face to expand, preferably at a controlled rate, which may be independent of any thermal expansion of the component caused by the additive process.

The biasing means may be a spring, hydraulic or pneumatic loaded connection.

The thermally conductive heat sink may comprise a plurality of faces which conform to the reverse side of the work-piece and which are separated by at least one groove containing a gel or fluid with a coefficient of thermal transfer greater than or equal to that of the component. Beneficially the high thermal conductivity reduces sideways thermal transfer within the component and can increase the heat removed by the heat sink.

The thermally conductive heat sink may comprise a thermally conductive gel or fluid contained within a flexible envelope, wherein the envelope conforms to the reverse side of the work-piece.

The fluid may be a grease, which may contain metallic, thermally conductive particles of, for example, copper.

The additive process may be a Shaped Metal Deposition (SMD) Process such as: TIG welding, MIG Welding, EB Welding or Direct Laser Deposition, for example.

According to a second aspect of the invention there is provided a method of supporting a work-piece during an additive process comprising the steps: a) providing a workpiece having a first surface and a reverse surface opposite the first surface, b) providing a thermally conductive heat-sink adapted to act against the reverse side of the workpiece, c) biasing the heat-sink against the workpiece, d) adding material to the first surface at a temperature that induces thermal expansion of the workpiece, and e) moving the heat-sink to maintain the bias against the workpiece.

Embodiments of the present invention will now be described by way of example only and with reference to the accompanying drawings, in which:—

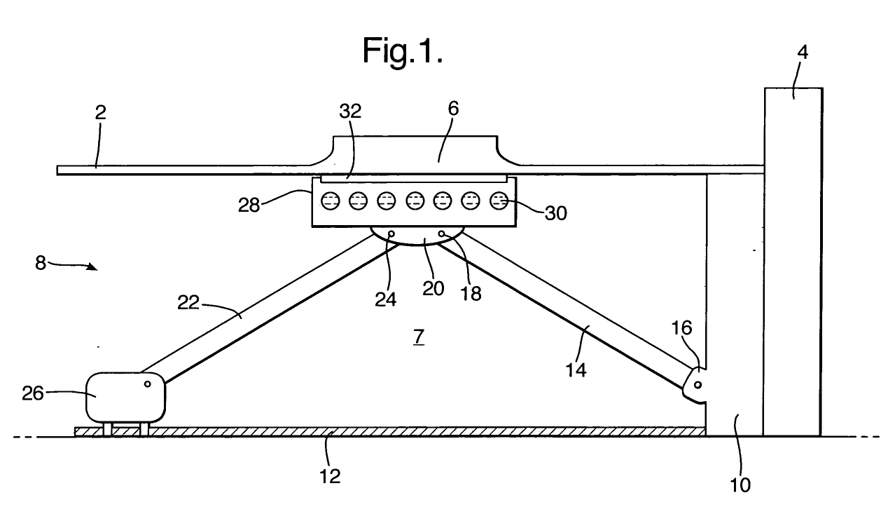

FIG. 1 depicts the cross-section of a combustor casing supported by tooling in accordance with a first embodiment of the present invention,

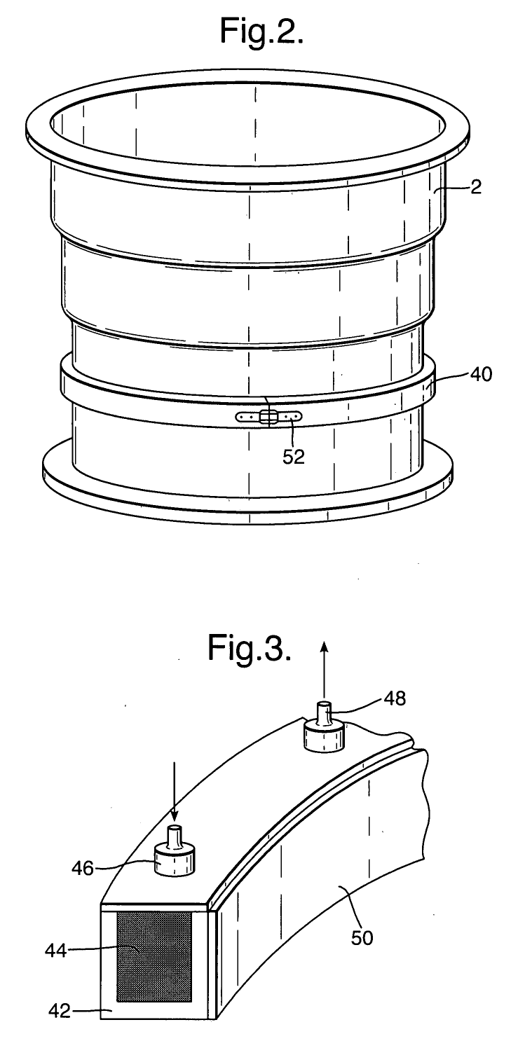

FIG. 2 depicts a perspective view of combustor casing supported by tooling in accordance with a second embodiment of the present invention.

FIG. 3 depicts a cross-section of the tooling in accordance with the second embodiment.

FIG. 1 depicts a combustor casing 2 formed of nickel alloy. Combustor casings are designed to neither buckle, nor rupture under the most extreme pressure loadings seen by the engine over the entire life of the combustor, which can be up to 100,000 hours for an industrial engine. It is important that the casing is not left with high levels of residual stress after the manufacture process is complete.

The casing has a diameter of 850 mm and a wall thickness of 12 mm. The finished casing comprises a number of features such as flange 4 and boss 6 manufactured using a TIG SMD process. The flange and the boss have a radial thickness of the order 50 mm. The inside of the casing 7 is supported by the heat sink tooling 8. The tooling comprises a first end 10 to which a linear screw thread 12 is mounted. The end 10 extends circumferentially and fits within the casing. A second end (not shown) is provided at the opposite end of the combustor casing and to which the second end of the screw thread is mounted.

Each of the ends is sized such that they just fit within the casing to support and stiffen the casing at each end. A first arm 14 is mounted to the first end by a pin joint 16 such that it pivots. The arm extends between the pivot joint at the first end and a second pivot joint 18 at a mount for a heat sink 20. The mount for the heat sink 20 is mounted to a second arm 22 in a pivoting manner by a third pivot joint 24. At the opposing end of the second arm an actuator element 26 is provided that is attached between the second arm 22 and the screw thread 12 in a pivotal manner such that rotary movement of the thread translates into linear movement of the actuator element 26 and consequently radial movement of the mount 20 for the heat sink.

The arms 14, 22 may be detached from the first end face and replaced with other arms of differing length to locate the mounting element of the heat sink the desired location relative to that of the feature 6 that is to be added. The length of the arms may be determined by simple and routine trigonometry. As an alternative, the arms may telescope to the correct length. However, such a construction adds to the complexity of the tooling, especially as sufficient stiffness is required to support the heated component during the additive process.

The heat sink 28 mounted to the heat sink mount 20 is a thermally conductive box structure of copper and contains a water cooling circuit 30 with a bifurcated feed to minimise the temperature difference across the heat sink. After flowing through the heat sink the water is passed to a chiller (not shown) where it is cooled before re-circulating back to the heat sink. The flow of water through the structure should be sufficient to absorb the heat input into the casing by the selected additive manufacture.

The heat sink has a thermally conductive coupling media 32 between the box structure 28 and the inside surface of the casing 2. The thermally conductive coupling media is a 500 micron layer of “Heat Ban”, or Magna 904 available from Magna Industrial Company, which is a jelly-like compound that conducts heat between the cylindrical casing and the heat sink whilst conforming to the surface of the casing to provide good thermal contact.

The foot print of the heat sink is greater than that of the additive boss to be formed. For a boss having a radius of 20 mm the heat sink has a radius of 30 mm. The larger footprint supports the casing during the additive process.

At the start of the additive process, the tooling is inserted into the casing and the heat sink biased against the inside surface such that it exerts a slight positive pressure sufficient to support the casing without generating unnecessary stress within the casing.

As discussed earlier, the SMD process used to deposit the boss in this embodiment is TIG (Tungsten Inert Gas) Deposition.

The casing is held within an enclosure filled with the inert gas argon. The argon prevents the casing, electrode and deposited material from reacting with gases in the atmosphere.

The TIG cathode of a tungsten matrix material is removed from the combustor casing by a short distance, typically 4-6 mm and an arc is created between the casing and the TIG electrode. The arc is of high temperature and creates a melt pool on the casing having a depth of 1-2 mm and surface diameter of a similar size. A nickel superalloy material is continuously fed into the arc and melted onto the melt pool, which has a temperature of around 1700° C.

The TIG cathode is moved relative to the substrate thereby moving the position of the melt pool and the point of deposition of the new material with a single pass of the TIG electrode a ridge of alloy is deposited that has a height of approximately 1 mm and a width of about 8 mm.

The heat from the deposition process induces thermal expansion of the casing of between 20-30 mm around the circumference of the casing. The expansion is not uniform in all directions and especially for the asymmetric feature of the boss, where the casing is unsupported or insufficiently supported, the expansion generates stresses and warping in the casing. The stresses induced by the thermal expansion are therefore mitigated by moving the heat sink radially, with the combustor casing, to maintain a relatively constant pressure against the reverse surface of the casing that is sufficient to support the expanded casing and so avoid warping of the combustor casing.

Where the additive feature is a circumferential flange it is possible to build this up in a number of passes whilst rotating the casing underneath the deposition tool. To avoid the necessity of having a heat sink extending the length of the inner circumference the heat-sink tooling remains static with respect to the deposition tooling and does not rotate with the casing.

According to a second embodiment of the invention the combustor casing 2 is supported by an external band heat sink structure 40 as depicted in FIG. 2.

The feature to be added, in this embodiment, is an internal flange having a width of 20 mm and a height of 16 mm. The flange is sited on the reverse surface of the casing to that of the heat sink structure and immediately opposite the heat sink.

The band, depicted in FIG. 3, has a width of 100 mm and a height of 50 mm, an outer skin 42 of steel and a hollow interior filled with copper turning 44 or vanes. An inlet port 46 and an outlet port 48 are provided to communicate with the interior of the band and supply a cooling fluid such as water, air or argon thereto.

One surface of the band conforms with the surface of the casing and the conformity is improved by applying a thermally conductive gel or grease 50 to the surface of the band. In this way good thermal contact is achieved.

The support band is biased against the surface of the combustor casing by a spring element 52 that secures the two ends of the band in proximity. The spring is tensioned to allow the band to expand radially as the casing expands because of heat input during the additive process. The tension provided by the spring is selected such that the pressure exerted to the casing does not create significant distortions to the material of the casing, but sufficient pressure is applied to limit distortion in the casing once the additive process is complete. Beneficially, the same positive pressure can be applied throughout the additive process.

Various modifications may be made without departing from the scope of the invention.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

We claim:

1. Apparatus for supporting a work-piece during an additive process where material is added to a first surface of the work-piece, the apparatus comprising
a thermally conductive heat-sink adapted to act against a reverse side of the work-piece to that to which material is added thereby supporting the work-piece,
wherein the thermally conductive heat-sink is mounted to a biasing means that in use biases the thermally conductive heat-sink against the reverse side of the work-piece, wherein the biasing means is adjustable to allow the thermally conductive heat-sink to move independently of the work-piece and provide a uniform pressure to the work-piece throughout the additive process.

2. Apparatus according to claim 1, wherein the thermally conductive heat-sink has a face that conforms with the reverse side of the work-piece, wherein the biasing means is adjustable to move the thermally conductive heat-sink in a direction that is generally perpendicular to the plane of the face.

3. Apparatus according to claim 1, wherein the thermally conductive heat-sink has a curved face that abuts the reverse side of the work-piece and the biasing means is adjustable to move the thermally conductive heat-sink in a direction that is generally perpendicular to the tangent of the face.

4. Apparatus according to claim 1, wherein the biasing means comprises a mount element to which one end of a first arm is pivotally attached, a support element for supporting the thermally conductive heat-sink pivotally attached to a second end of the first arm, a second arm having a first end pivotally attached to the support element and a second end pivotally attached to an actuator element adapted to move in use to move thermally conductive heat-sink independently of the work-piece.

5. Apparatus according to claim 4, wherein the movement of the thermally conductive heat-sink is orthogonal to the reverse side of the work-piece.

6. Apparatus according to claim 4, wherein the movement of the actuator element is orthogonal to the movement of the thermally conductive heat-sink.

7. Apparatus according to claim 4, wherein the actuator element moves linearly and is functionally mounted to a screw thread actuator or linear actuator.

8. Apparatus according to claim 1, wherein in use the work-piece is cylindrical and the thermally conductive heat-sink acts against the internal surface of the work-piece.

9. Apparatus according to claim 1, wherein the thermally conductive heat-sink is provided with a temperature adjusting circuit for the supply and removal of a coolant or heating medium to the heat-sink.

10. Apparatus according to claim 1, wherein in use the work-piece is cylindrical and the thermally conductive heat sink acts against the external surface of the work-piece.

11. Apparatus according to claim 10, wherein the thermally conductive heat-sink comprises a band of conductive material that encircles a portion of the external surface of the work-piece.

12. Apparatus according to claim 11, wherein the band comprises a series of pivotally connected segments.

13. Apparatus according to claim 11, wherein the band of conductive material comprises a first end with a face and second end with a face, wherein the first face and the second face are held adjacent to each other by the biasing means which allows a gap between the first and second face to expand.

14. Apparatus according to claim 13, wherein the biasing means is a spring, hydraulic or pneumatic loaded connection.

15. Apparatus according to claim 1, wherein the thermally conductive heat sink comprises a plurality of faces which conform to the reverse side of the work-piece and which are separated by at least one groove containing a gel or fluid with a coefficient of thermal transfer greater than that of the workpiece.

16. Apparatus according to claim 1, wherein the thermally conductive heat sink comprises a thermally conductive gel or fluid contained within a flexible envelope, wherein the envelope conforms to the reverse side of the work-piece.

17. A method of supporting a work-piece during an additive process comprising the steps:
a) providing a workpiece having a first surface and a reverse surface opposite the first surface,
b) providing a thermally conductive heat-sink adapted to act against the reverse side of the workpiece
c) biasing the heat-sink against the workpiece
d) adding material to the first surface at a temperature that induces thermal expansion of the workpiece, and
e) moving the heat-sink to maintain the bias against the workpiece.

18. A method according to claim 17, wherein biasing means moves the thermally conductive heat-sink in a direction that is generally perpendicular to the plane of the face.

19. A method according to claim 17, wherein the thermally conductive heat-sink has a curved face that abuts the reverse side of the work-piece and the biasing means moves the thermally conductive heat-sink in a direction that is generally perpendicular to the tangent of the face.

20. A method according to claim 17, wherein a coolant or heating medium is supplied to the heat-sink through a temperature adjusting circuit.

21. A method according to claim 17, wherein the heat-sink comprises a band of conductive material that encircles a portion of the external surface of the work-piece which is moved through a series of pivotally connected segments.

22. A method according to claim 17, wherein the heat-sink comprises a band of conductive material that encircles a portion of the external surface of the work-piece and which comprises a first end with a face and second end with a face, wherein the first face and the second face are held adjacent to each other by the biasing means which expands to allow a gap between the first and second face to expand.
